(19) United States
(12) Patent Application Publication
(10) Pub. No.: US 2013/0236045 A1
(43) Pub. Date: Sep. 12, 2013

(54) ELECTRONIC APPARATUS FOR PREVENTING SPEAKERS FROM MAKING UNWANTED NOISE

(71) Applicants: XUE-FENG WAN, Shenzhen City (CN); PING LI, Shenzhen City (CN)

(72) Inventors: XUE-FENG WAN, Shenzhen City (CN); PING LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/448,424

(22) Filed: Apr. 17, 2012

(30) Foreign Application Priority Data
Mar. 9, 2012 (CN) 201210061079.X

(51) Int. Cl. H04R 1/02

(52) U.S. Cl. 381/392

(57) ABSTRACT

The present disclosure provides an electronic apparatus for preventing speakers from making unwanted noise. A joint element is fixed on a back cover of the electronic apparatus. Therefore, the back cover is in contact with a screen of the electronic apparatus via the joint element constantly and four elements which are a speaker, a front cover, the back cover, and the screen are directly or indirectly connected with each other to avoid generating resonating points and making unwanted noise from the speaker.

### BACKGROUND

1. Technical Field

The disclosure relates to electronic apparatuses and, more particularly, to an electronic apparatus for preventing speakers from making unwanted noise.

2. Description of Related Art

Electronic apparatuses, such as tablet computers, mobile phones, have become thinner and thinner. It is easy to get unwanted noise from a speaker when the speaker of the electronic apparatus is playing sound due to space restriction. For example, when the speaker plays sounds in a predetermined frequency, the speaker and the cover of the electronic apparatus may easily resonate, which results in the speaker making unwanted resonating noise.

Therefore, what is needed is an electronic apparatus for preventing speakers from making unwanted noise to overcome the described shortcoming.

### BRIEF DESCRIPTION OF THE DRAWINGS

FIG. 1 is a perspective view of an electronic apparatus in accordance with an exemplary embodiment.

FIG. 2 is an exploded, perspective view of the electronic apparatus of FIG. 1, in accordance with a first exemplary embodiment.

FIG. 3 is an exploded, perspective view of the electronic apparatus of FIG. 1, in accordance with a second exemplary embodiment.

FIG. 4 is an enlarged view of a joint element of the electronic apparatus of FIG. 1.

FIG. 5 is a cross-sectional view taken along line V-V of FIG. 1.

### DETAILED DESCRIPTION

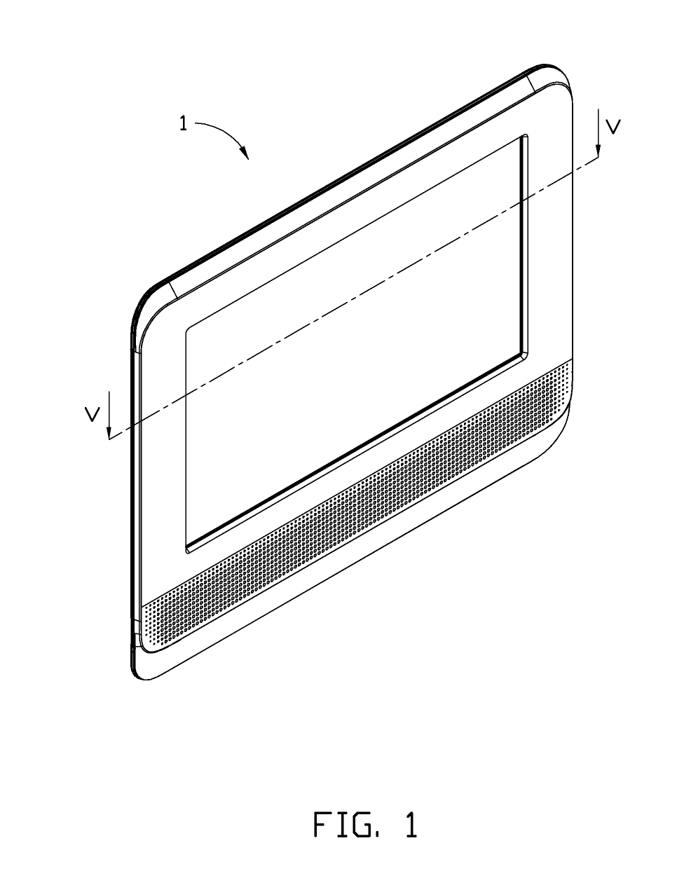

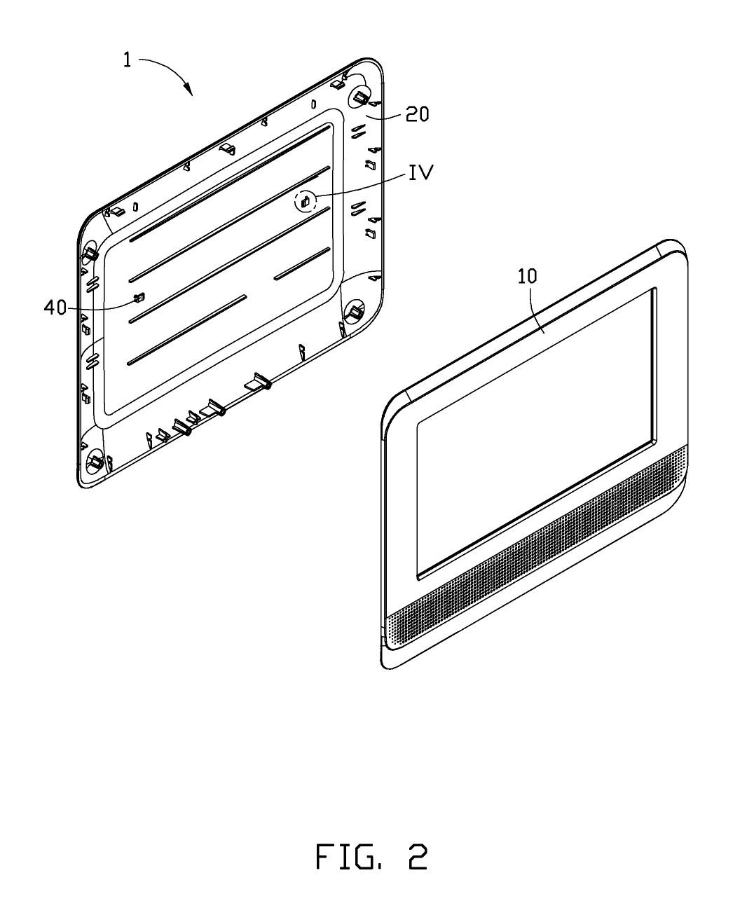

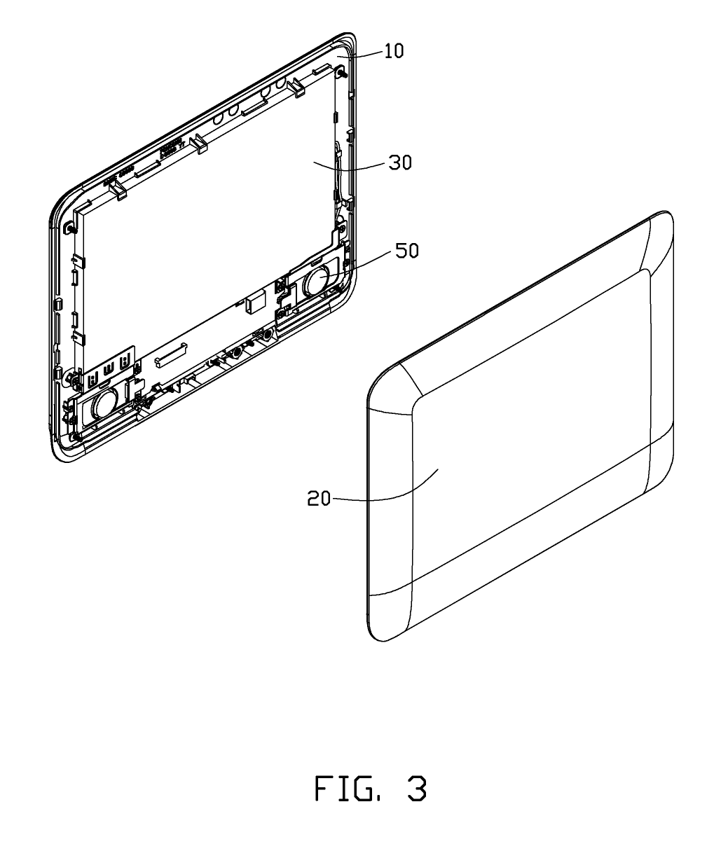

FIGS. 1-3, show an electronic apparatus employing a speaker for playing sounds. For illustration purposes, a tablet computer 1 is used as an example. The tablet computer 1 includes a front cover 10, a back cover 20, and a screen 30. The screen 30 is accommodated between the front cover 10 and the back cover 20.

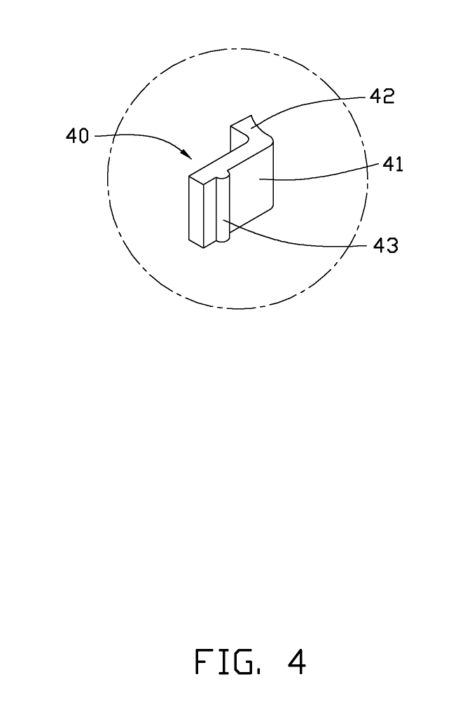

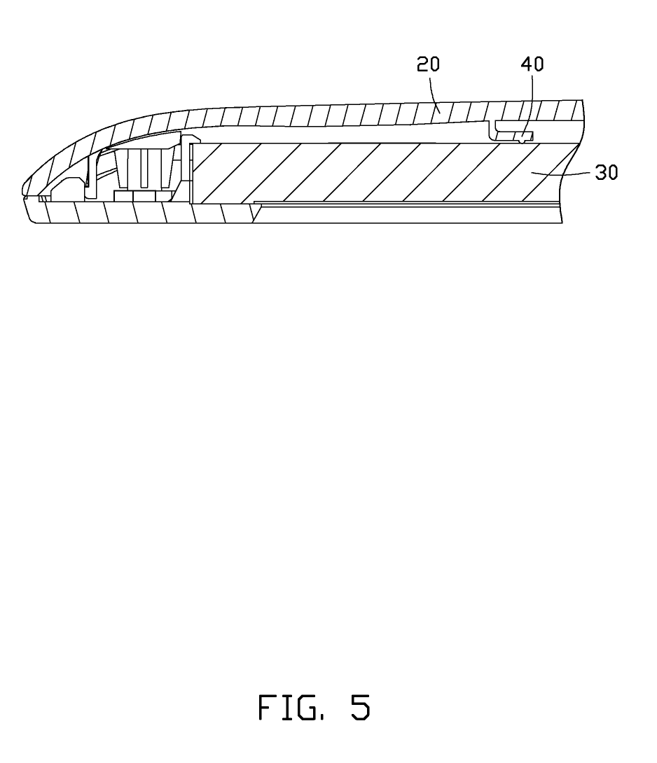

FIGS. 4-5, show a joint element 40 fixed on the back cover 20 and abutting a rear side of the screen 30. The joint element 40 is made of elastic material. Therefore, the back cover 20 is in contact with the screen 30 via the joint element 40 constantly.

The joint element 40 is a cantilever and can be designed with a number of shapes, such as, substantially, L-shaped, T-shaped, upside-down L-shaped, or upside-down T-shaped. In the embodiment, the joint element 40 is a shape of “L” and comprises a body 41, a connection portion 42, and a protrusion portion 43. The body 41 is a rectangular, the connection portion 42 vertically extends from the body 41 and is fixed on the back cover 20, and the protrusion portion 43 is positioned on the external surface of the body 41.

A speaker 50 is positioned on the front cover 10. The back cover 20 is connected with the screen 30 via the joint element 40. The protrusion portion 43 of the joint element 40 is on the top of the screen 30, and therefore, four elements which include the speaker 50, the front cover 10, the back cover 20, and the screen 30 are directly or indirectly connected with each other, thereby avoiding resonating points when the speaker 50 plays sounds and prevents the speaker 50 from making unwanted noise.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic apparatus for preventing speaker from making noise, the apparatus comprising:
a front cover;
a back cover;
a screen accommodated between the front cover and the back cover;
a speaker positioned on the front cover; and
a joint element fixed on the back cover and abutting a rear side of the screen;
wherein the back cover is in contact with the screen via the joint element constantly, and the speaker, the front cover, the back cover, and the screen are directly or indirectly connected with each other.

2. The electronic apparatus as recited in claim 1, wherein the joint element is made of elastic material.

3. The electronic apparatus as recited in claim 1, wherein the joint element is a shape of “L” and comprises a body, a connection portion, and a protrusion portion, the body is a rectangular, the connection portion vertically extends from the body and is fixed on the back cover, and the protrusion portion is positioned on the external surface of the body.

4. The electronic apparatus as recited in claim 3, wherein the protrusion portion is on the top of the screen.

5. The electronic apparatus as recited in claim 1, wherein the joint element is a cantilever.
